(19) United States
(12) Patent Application Publication
(10) Pub. No.: US 2024/0217023 A1
(43) Pub. Date: Jul. 4, 2024

(54) Combined Extraction/Shielding Gas Nozzle of an Arc Welding Torch with a Non-Consumable Electrode and Torch Body Comprising a Combined Extraction/Shielding Gas Nozzle

(71) Applicant: Alexander Binzel Schweisstechnik GmbH & Co. KG, Buseck (DE)

(72) Inventors: Sascha Rose, Fernwald (DE); Jannik Muzica, Mornshausen (DE); Dietmar Cuda, Laubach (DE)

(73) Assignee: Alexander Binzel Schweisstechnik GmbH & Co. KG, Buseck (DE)

(21) Appl. No.: 18/558,206

(22) PCT Filed: Mar. 15, 2022
(86) PCT No.: PCT/EP2022/056708

§ 371 Date: Oct. 31, 2023

(30) Foreign Application Priority Data
May 6, 2021 (DE) 10 2021 111 780.1

(51) Int. Cl. B23K 9/32; B23K 9/167

(52) U.S. Cl. CPC B23K 9/325; B23K 9/167

(57) ABSTRACT

A combined extraction/shielding gas nozzle of an arc welding torch with a non-consumable electrode, such as a TIG or plasma torch, is attached to a torch body and has a shielding gas channel for supplying shielding gas to the welding process, and has an extraction device connected integrally to the shielding gas channel, for extracting the flue gas produced during the welding process. The flue gas discharge is arranged via the torch head and a guide on the torch body into the handle, rather than via a separate bypass line The flue gas is directed from the nozzle on the torch head through the torch body of the nozzle to the handle of the welding torch.

### CROSS-REFERENCE TO RELATED APPLICATIONS

This application is a national stage application (under 35 USC § 371) of PCT/EP2022/056708, filed Mar. 15, 2022, which claims benefit of DE 102021111780.1, filed May 6, 2021, the contents of each of which is incorporated by reference herein.

### BACKGROUND OF THE INVENTION

### Technical Field and State of the Art

The invention relates to a combined extraction/shielding gas nozzle of an arc welding torch with non-consumable electrode as well as to a torch body for thermal joining of at least one workpiece, in particular for arc welding, with a combined extraction/shielding gas nozzle.

Thermal arc joining processes use energy to melt the workpieces and join them. In sheet metal production, “MIG”, “MAG”, as well as “TIG” and “plasma” welding are used as standard.

Arc welding devices generate an arc between the workpiece and a consumable or non-consumable welding electrode to melt the weld metal. The weld metal as well as the weld joint are shielded from the atmospheric gases, mainly N2, O2, H2, of the ambient air by a stream of shielding gas.

The welding electrode is in this case provided on a torch body of a welding torch that is connected to an arc welding unit. The torch body typically accommodates a group of interior welding current guiding components that guide the welding current from a welding current source in the arc welding unit to the tip of the torch head onto the welding electrode, in order to then generate the arc from there to the workpiece.

The stream of shielding gas flows around the welding electrode, the arc, the weld puddle, and the heat-affected zone on the workpiece, and is then fed to these regions by the torch body of the torch. A gas nozzle guides the stream of shielding gas to the front end of the torch head, where the stream of shielding gas exits from the torch head approximately annularly about the welding electrode.

In the state of the art, the gas is usually conducted to the gas nozzle via components made of a material with low electrical conductivity (polymers or oxide ceramics), which can also serve as insulation.

During the welding operation, the arc generated for welding heats up the workpiece to be welded and the fed weld metal, if any, such that these are melted. The arc energy input, high-energy thermal radiation and convection result in significant heat input to the torch head of the welding torch. Part of the heat introduced can be dissipated by the flow of shielding gas through the torch head or by passive cooling in the ambient air and heat conduction into the hose assembly.

Above a certain welding current load on the torch head, however, the heat input is so great that so-called active cooling of the torch head is required to protect the components used from thermal material failure. For this purpose, the torch head is actively cooled with a coolant which flows through the torch head and thereby removes the unwanted heat absorbed from the welding process. For example, deionized water with additives of ethanol or propanol can be used as a coolant for the purpose of frost protection.

In addition to welding, brazing is yet another alternative to join sheet metal components. Other than for welding, brazing does not involve melting the workpiece, but only the filler material. The reason for this is that brazing joins two edges with the weld metal as the filler material. The melting temperatures of the weld metal and the component materials lie far apart, which is why only the weld metal melts during the operation. For brazing, in addition to TIG, plasma, and MIG torches, LASER is also suitable.

Argon I1 or Ar mixtures with admixtures of CO2, O2, or H2 according to DIN ISO 14175 can usually be used for arc brazing. Commercially available TIG torches can be used for TIG brazing.

According to the type, cooling of the non-consumable electrode and thus of the torch can be achieved by keeping the surfaces of the torch components around which the shielding gas flows as large as possible.

To capture the flue gases and pollutants generated during welding as close as possible to the point of origin, i.e., the welding process, torches with integrated extraction systems are provided.

EP 2 298 485 A1 describes a torch with an extraction housing which encloses the torch neck in a relatively short section. An extraction hose is connected to the extraction housing, which is routed parallel to the remaining section of the torch neck and to the handle with the torch hose assembly.

EP 0 835 711 A2 relates to a welding torch with an extraction pipe enclosing the torch neck and forming a flue gas channel in the interspace. The extraction pipe merges into an extraction nozzle in the front region. The flue gas is extracted directly at the welding point. The extraction pipe is firmly connected to the torch neck by means of a triple bar and a union nut. At the handle end, the extraction pipe opens into an extraction hose guided in the manner of a bypass on the outside next to the handle of the torch.

A TIG welding torch with a flue gas extraction device is known from EP 3 300 827 A1. An extraction housing is attached directly to the torch head. The flue gas drawn in via the extraction housing is directed through a flexible hose in the manner of a bypass parallel to the torch neck and fed downstream via the handle section and a hose assembly connected to it to an extraction blower.

From JP 2021-023 972 A, a torch device for arc welding is known with a torch housing in which an electrode rod is arranged, and with a nozzle arranged on the torch housing, which has a first unit surrounding the electrode rod. Furthermore, the nozzle has a shielding gas discharge opening and a welding fume extraction opening.

A disadvantage of such a device is that the handling of the torch is restricted by the extraction device arranged at the torch head. In particular, an attachment of the extraction nozzle to the torch head known from the prior art is disadvantageous because the design of the torch head must be changed. There is no interchangeability of the torch body with or without extraction. In addition, due to the routing of the flue gas via the pipe running parallel to the torch neck, the extracted volume flow is severely limited.

Based on the disadvantages described above, the invention is based on the task of specifying an improved gas nozzle and an improved torch body which have a compact design and ensure safe and simple operation.

### SUMMARY OF THE INVENTION

The invention relates to a combined extraction/shielding gas nozzle of an arc welding torch with a non-consumable electrode, such as a TIG or plasma torch, comprising a shielding gas channel for supplying shielding gas to the welding process, and an extraction device, connected integrally to the shielding gas channel, for extracting the flue gas produced during the welding process.

As mentioned in the Background above, in the prior art it is disadvantageous that the flue gas extracted via a nozzle on the torch head is fed via a hose in the manner of a bypass into the handle and from there is discharged via the hose assembly, because this greatly limits the handling of the torch.

In contrast, the invention proposes to attach the extraction device to the handpiece. Thus, while in the prior art the nozzle is fixed to the torch head, in the invention the flue gas discharge is arranged via the torch head and a guide on the torch body into the handle, rather than via a separate bypass line. In the invention, the flue gas is directed from the nozzle on the torch head through the torch body of the nozzle to the handle.

In addition, the welding torch with nozzle according to the invention can only be used in the assembled state of the nozzle with extraction region, because the shielding gas channel is integrally connected to the extraction device. Due to this safety feature, the user is optimally protected from flue gases.

Furthermore, due to the one-piece design, less installation space is required and fewer components are needed in the overall design, which allows for a simpler design of the individual components.

Furthermore, due to the monolithic design of the shielding gas channel and extraction device, the nozzle is reduced in weight and size compared to the state of the art.

According to a first advantageous embodiment of the invention, the extraction device has at least one extraction channel for the flue gas at least in regions coaxially surrounding the shielding gas channel. In this way, the flue gas produced during the welding process is guided in the at least one extraction channel coaxially with the shielding gas in the shielding gas channel. Accordingly, the flue gas flows in the nozzle in the opposite direction to the shielding gas. This design allows a particularly compact construction of the nozzle. Preferably, the shielding gas channel and the extraction channel can be arranged centrically to each other.

According to the invention, the extraction device has several extraction openings for the flue gas arranged on the periphery of the torch body, preferably evenly distributed over the torch body. The extraction openings can be arranged at approximately the same distance from each other, wherein each extraction opening being in fluid communication with the extraction device via the extraction channel. In this way, the flue gas is extracted evenly. Preferably, an even number of extraction openings can be provided to allow the nozzle to be molded.

According to a further variant, the nozzle is designed to be electrically insulating, in particular it consists essentially of a ceramic material, preferably aluminum oxide. The ceramic is both temperature resistant and electrically insulating. Assembly and disassembly are nevertheless simple and not as complex as with nozzles known from the prior art.

It is particularly advantageous that the extraction openings of the extraction device are arranged axially offset from the shielding gas outlet of the nozzle with respect to the longitudinal axis of the nozzle. The flue gas is therefore routed via the inlet nozzle, but in contrast to the state of the art, no modification to the torch head is required here. Routing the flue gas coaxially with the actual torch body to the housing is easy to implement. It does not require a bypass, and most importantly, it does not require any modification of the torch body itself.

In a further development of the invention, it is provided that the shielding gas channel and the at least one extraction opening are arranged offset radially and in the axial direction. This outward rather than forward orientation is of particular importance for the extraction of ozone as a gaseous pollutant induced by the arc radiation only at some distance from the process. Here, the invention creates a greater degree of freedom by arranging the extraction section, i.e., the extraction openings, further to the rear and directed outwards. In contrast, in the prior art embodiment, the torch head itself must be modified because the intake nozzle is placed on the torch head, namely in the region where the ceramic nozzle of the torch is attached.

Another advantage of this design is that the extraction of the flue gas and the supply of the shielding gas take place one after the other in the direction of flow, i.e., shielding gas flows out at the front end of the nozzle and, viewed in the flue gas extraction direction, is first extracted behind it. This largely avoids heating of the shielding gas by hot flue gases.

According to an advantageous embodiment of the invention, it is provided that the extraction device has a dome-shaped or domed region at its end facing the shielding gas outlet opening. Such a design can influence the size of the region of the component surface covered by the shielding gas.

The extraction openings can be provided at least in regions in the dome-shaped or domed region of the extraction device.

It is particularly advantageous that the flow cross-section of the shielding gas channel widens towards the torch-side end of the nozzle. In this way, the accessibility of the narrow points in the nozzles is improved.

According to an advantageous further development of the invention, the extraction channel connects to the shielding gas channel in the region in which the shielding gas channel widens towards the torch-side end of the nozzle.

The aim is to achieve a homogeneous, turbulence-free shielding gas flow. The design of the shielding gas channel depends on the accessibility and in some cases also on the view of the arc, the tungsten electrode, or the weld metal. The standard shape of a nozzle is round. An oval shape is also conceivable in narrow-gap applications, among others, where the secondary axis ensures accessibility and the main axis enlarges the flow space so that the flow velocity does not become too high and turbulence is avoided.

Basically, round is advantageous in almost all applications because it is orientation independent.

According to an advantageous further development of the invention, it is provided that the extraction openings have an elliptical or oval-shaped cross-section, in particular that the main axis of the elliptical or oval-shaped cross-section extends approximately parallel to the longitudinal axis of the nozzle.

In another advantageous variant of the invention, the nozzle has a thread, in particular a threaded insert for screwing onto a torch body. In this way, easy assembly and interchangeability of the nozzle on the torch, in particular on the torch body, is ensured.

The nozzles can be designed in different lengths. For example, short or long variants can be used in different application boundary conditions. These variants differ in terms of the quality of the shielding gas coverage due to the different laminarization sections. Furthermore, the different length of the nozzles also causes a different length of the tungsten electrode, which also has an influence on the current carrying capacity due to the ohmic heating in the electrode. Thus, the length of the nozzles also has limited influence on the welding process.

An independent idea of the invention relates to a torch body for thermal joining of at least one workpiece, in particular for arc welding, with a nozzle described above.

According to an advantageous further embodiment of the invention, an extraction pipe for extracting the flue gas is in fluid communication with the extraction device of the nozzle.

It is conceivable that the extraction tube is part of a handle for the torch, in particular that the handle is formed from two half-shells.

Furthermore, the invention relates to a torch having a torch body described above.

Further objectives, advantages, features, and applications of the present invention are derived from the subsequent description of an exemplary embodiment by way of the drawings. All described and/or depicted features per se or in any combination constitute the subject matter of the present invention, regardless of their summary in the patent claims or their back-reference.

### DESCRIPTION OF THE DRAWINGS

Partially schematically, the drawings show:

FIG. 1 a perspective view of a combined extraction/shielding gas nozzle,

FIG. 2 a sectional view of the nozzle according to FIG. 1 with an internal thread for screwing onto a torch body,

FIG. 3 another sectional view of the nozzle according to FIG. 1,

FIG. 4 a torch body with nozzle according to FIG. 1, and

FIG. 5 a sectional view of the torch body according to FIG. 4.

Identical or identically functioning components are provided with reference numerals based on an embodiment in the subsequently depicted figures of the illustration in order to improve readability.

### DETAILED DESCRIPTION

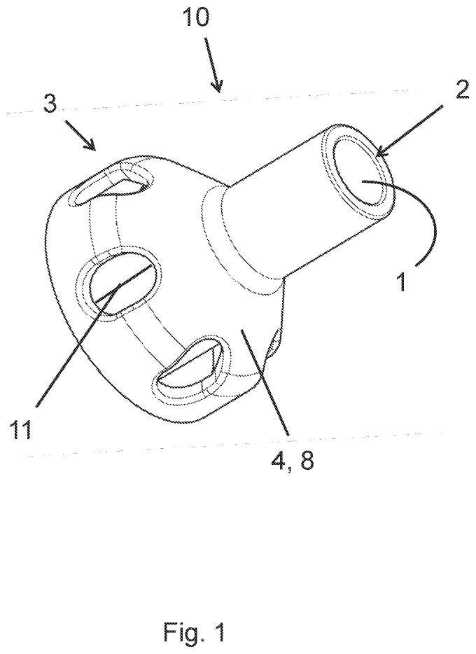

FIG. 1 shows a combined extraction/shielding gas nozzle 10 for an arc welding torch with a non-consumable electrode, in particular a TIG or plasma torch.

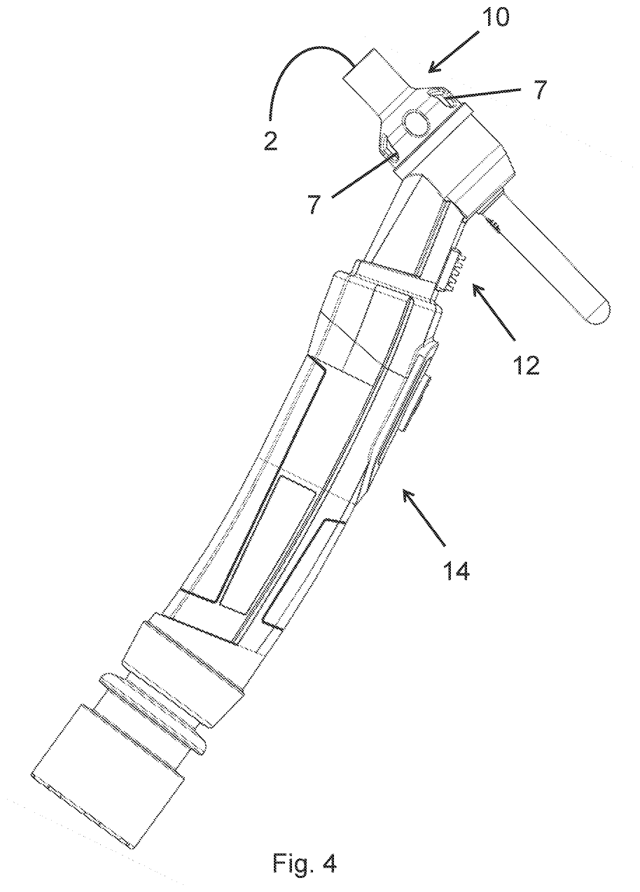

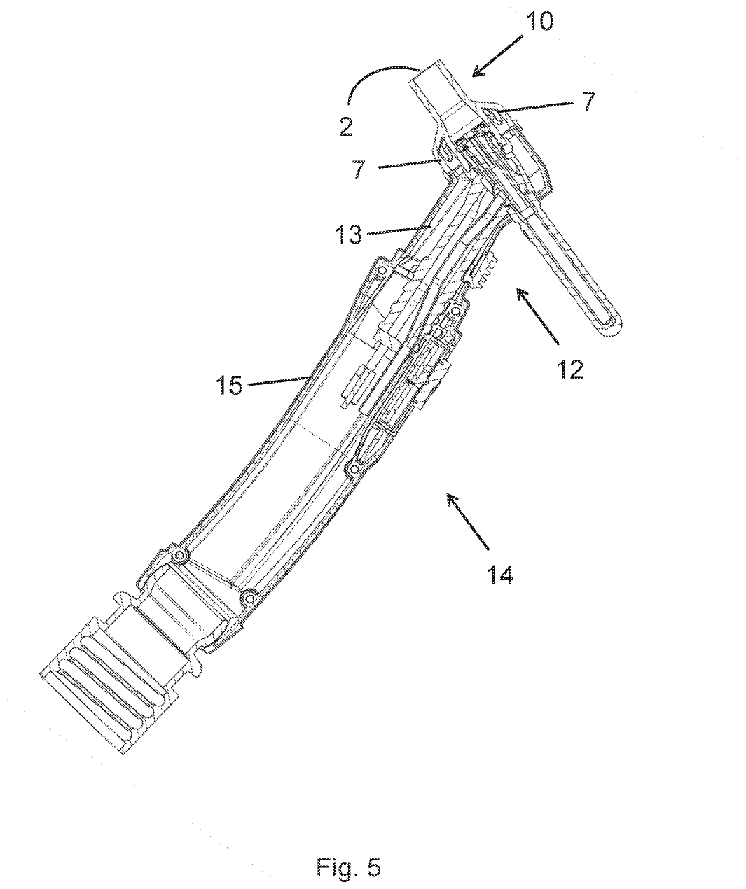

This nozzle 10 is arranged on a torch head of the torch body 12 not shown in FIG. 1, in particular screwed on. Such a torch body 12 is shown in FIGS. 4 and 5.

The nozzle 10 has a shielding gas channel 1 for supplying shielding gas to the welding process, which in the present embodiment is guided centrally in the nozzle 10.

In the present case, the shielding gas channel 1 is integrally connected to an extraction device 3, which is connected to the shielding gas channel 1, for extracting the flue gas occurring during the welding process.

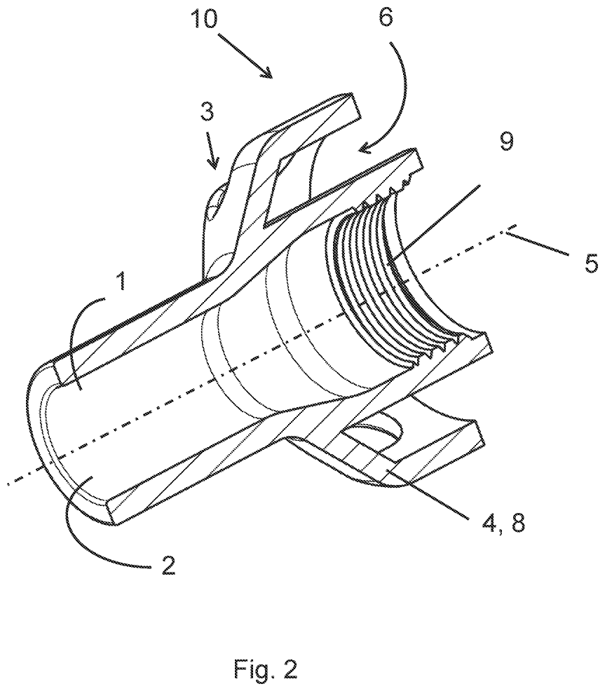

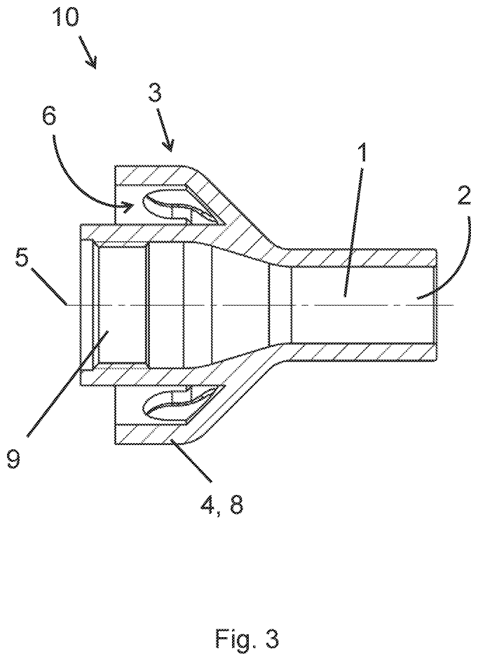

In the exemplary embodiment described here, the extraction device 3 has an extraction channel 6 (see FIGS. 2 and 3) for the flue gas, which coaxially surrounds the shielding gas channel 1 at least in regions. Several extraction openings 7 for extracting the flue gas are provided on the periphery of the torch body, in this case evenly arranged over the torch body. These extraction openings 7 are in fluid communication with the at least one extraction channel 6. Preferably, the shielding gas channel 1 and the extraction channel 6 can be arranged centrically to each other.

The extraction openings 7 may have an elliptical or oval cross-section, and the main axis 11 of the elliptical or oval cross-section may extend approximately parallel to the longitudinal axis 5 of the nozzle 10.

The extraction openings 7 of the extraction device 3 are axially offset with respect to the nozzle longitudinal axis 5 from the shielding gas outlet opening 2 of the nozzle 10. In addition, the shielding gas channel 1 and the at least one extraction opening 7 are offset radially and in the axial direction. In other words, the extraction openings 7 are set back from the gas outlet 2 for the shielding gas in the direction of flow of the flue gas and are offset radially outward, so that these extraction openings 7 are spaced apart from the welding process.

The flue gas or pollutants produced in the welding process are thus sucked into the at least one extraction channel 6 through the extraction openings 7 and extracted through an extraction pipe or extraction channel 13 arranged in a handle of the torch. The extraction of the flue gas and the supply of the shielding gas take place one after the other in the direction of flow, i.e., shielding gas flows out at the front end of the nozzle 10 and, viewed in the flue gas extraction direction, is first extracted behind it. This largely avoids heating of the shielding gas by hot flue gases.

As can be seen further from FIGS. 1 through 3, the extraction device 3 has a dome-shaped or domed region 4 at its end 8 facing the shielding gas outlet opening 2, the extraction openings 7 being provided at least in regions in the dome-shaped or domed region 4 of the extraction device 3.

As can be seen in particular from the sectional view shown in FIG. 2, the flow cross-section of the shielding gas channel 1 widens towards the torch-side end of the nozzle 10. The extraction channel 6 connects to the shielding gas channel 1 in the region in which the shielding gas channel 1 widens towards the torch-side end of the nozzle 10.

The nozzle 10 is electrically insulating. For this purpose, it is made of a ceramic material, preferably aluminum oxide.

As can be seen from FIGS. 4 and 5, the nozzle 10 is arranged on the torch body 12 for thermal joining of at least one workpiece, in particular for arc welding. FIG. 2 shows that the nozzle 10 in the present exemplary embodiment has a thread 9 for screwing onto the torch body 12. It is also conceivable that the nozzle 10 has a threaded insert for screwing onto the torch body 12.

Further, FIGS. 4 and 5 show an extraction pipe 13 for extracting the flue gas, which is in fluid communication with the extraction device 3 of the nozzle 10.

The extraction pipe 13 is part of a handle 14 for the torch, which in this case is formed from two half shells 15.

### REFERENCE NUMERALS

1 Shielding gas channel
2 Shielding gas outlet opening
3 Extraction device
4 Dome-shaped or domed region
5 Longitudinal axis of the nozzle
6 Extraction channel
7 Extraction opening
8 End of the extraction device
9 Thread
10 Shielding gas extraction nozzle
11 Main axis of the elliptic cross-section
12 Torch body
13 Extraction pipe
14 Handle
15 Half shells

1. A combined extraction/shielding gas nozzle (10) of an arc welding torch with a non-consumable electrode, comprising:
a shielding gas channel (1) for supplying shielding gas during a welding process, and
an extraction device (3), connected integrally to the shielding gas channel (1), for extracting flue gas produced during the welding process, wherein the extraction device (3) has a plurality of extraction openings (7) for the flue gas that are arranged uniformly over the nozzle (10) on the periphery.

2. The nozzle (10) according to claim 1, wherein the extraction device (3) has at least one extraction channel (6) for the flue gas coaxially surrounding the shielding gas channel (1) at least in regions.

3. The nozzle (10) according to claim 1, wherein the nozzle is electrically insulating.

4. The nozzle (10) according to claim 3, wherein the nozzle (10) consists essentially of a ceramic material.

5. The nozzle (10) according to claim 1, wherein the shielding gas channel defines an outlet (2) and wherein the extraction openings (7) of the extraction device (3) are arranged axially offset with respect to the nozzle longitudinal axis (5) relative to the shielding gas outlet (2) of the nozzle (10).

6. The nozzle (10) according to the extraction openings (7) are arranged radially and offset in the axial direction from the shielding gas channel (1).

7. The nozzle (10) according to claim 1, wherein the shielding gas channel defines an outlet opening (2), and wherein the extraction device (3) has a dome-shaped or domed region (4) at an end (8) of the extraction device (3) facing the shielding gas outlet opening (2).

8. The nozzle (10) according to claim 7 wherein the extraction openings (7) are provided at least in regions in the dome-shaped or domed region (4) of the extraction device (3).

9. The nozzle (10) according to claim 1, wherein the nozzle (10) has a torch-side end and the shielding gas channel (1) has a flow cross section, and wherein the flow cross section of the shielding gas channel (1) widens towards the torch-side end of the nozzle (10).

10. The nozzle (10) according to claim 9 wherein the extraction channel (6) adjoins the shielding gas channel (1) in the region in which the shielding gas channel (1) widens towards the torch-side end of the nozzle (10).

11. The nozzle (10) according to claim 1, wherein the extraction openings (7) have an elliptical or oval-shaped cross-section.

12. The nozzle (10) according to claim 11, wherein the nozzle (10) defines a longitudinal axis (5) and wherein the major axis (11) of the elliptical or oval cross-section extends approximately parallel to the longitudinal axis (5) of the nozzle (10).

13. The nozzle (10) according to claim 1, wherein the nozzle (10) has a thread (9) for screwing connection onto a torch body (12).

14. A torch body (12) for thermal joining of at least one workpiece, comprising:
a combined extraction/shielding gas nozzle (10) of an arc welding torch with a non-consumable electrode comprising a shielding gas channel (1) for supplying shielding gas during a thermal joining process, and an extraction device (3), connected integrally to the shielding gas channel (1), for extracting flue gas produced during the welding process, wherein the extraction device (3) has a plurality of extraction openings (7) for the flue gas that are arranged uniformly over the nozzle (10) on the periphery.

15. The torch body (12) according to claim 14, further comprising an extraction pipe (13) for extracting the flue gas is in fluid communication with the extraction device (3) of the nozzle (10).

16. The torch body (12) according to claim 15, wherein the extraction pipe (13) is part of a handle (14) for the torch and the handle (14) is formed of two half-shells (15).

17. An arc welding torch, comprising:
a torch body (12) comprising
a handle (14);
a combined extraction/shielding gas nozzle (10) operatively joined to the handle (14), the combined extraction/shielding gas nozzle (10) comprising a shielding gas channel (1) for supplying shielding gas during a thermal joining process, and an extraction device (3), connected integrally to the shielding gas channel (1), for extracting flue gas produced during the welding process, wherein the extraction device (3) has a plurality of extraction openings (7) for the flue gas that are arranged uniformly over the nozzle (10) on the periphery; and an extraction pipe (13) for extracting the flue gas in fluid communication with the extraction device (3) of the nozzle (10).

18. The torch of claim 17, wherein the extraction pipe (13) is part of the handle (14) of the torch body.

19. The torch of claim 17, wherein the torch is a TIG or plasma torch.
